(19) United States
(12) Patent Application Publication
(10) Pub. No.: US 2021/0340432 A1
(43) Pub. Date: Nov. 4, 2021

(54) Methods of Using Delayed Release Well Treatment Composititions

(71) Applicant: Baker Hughes Holdings LLC, Houston, TX (US)

(72) Inventors: Sumit Bhaduri, The Woodlands, TX (US); D.V. Satyanarayana Gupta, The Woodlands, TX (US); Shawn Shipman, Minot, ND (US)

(21) Appl. No.: 16/973,714

(22) PCT Filed: Jul. 30, 2019
(86) PCT No.: PCT/US2019/044156

§ 371 Date: Dec. 9, 2020

Related U.S. Application Data
(60) Provisional application No. 62/711,920, filed on Jul. 30, 2018.

(51) Int. Cl. C09K 8/70; C09K 8/536; C09K 8/03; C09K 8/58; E21B 47/11

(52) U.S. Cl. CPC C09K 8/70; C09K 8/536; C09K 8/03; C09K 2208/20; E21B 47/11; C09K 2208/32; C09K 2208/22; C09K 8/58

(57) ABSTRACT

A composite for controlling the release of a well treatment agent or for inhibiting or preventing the formation of contaminants into a fluid or a surface within a reservoir contains a well treatment agent adsorbed onto a water-insoluble or oil-insoluble adsorbent, the adsorbent having a surface area between from about 110 m²/g to about 700 m²/g. The composite may be also used to monitor the production of fluids from the reservoir or the flow of fluids in the reservoir.

### FIELD OF THE DISCLOSURE

A method for releasing a treatment agent into a well or into a conduit extending to or from a well is provided wherein the treatment agent is adsorbed onto a water-insoluble substrate to render a composite. The surface area of the adsorbent is between from about 110 m²/g to about 700 m²/g. The well treatment agent is slowly released from the substrate into the well or conduit.

### BACKGROUND OF THE DISCLOSURE

In a typical hydraulic fracturing operation, a fracturing fluid containing a solid proppant is pumped into a formation penetrated by a wellbore at a sufficient pressure to cause the formation or enlargement of fractures in the reservoir. Typically, the subterranean formation has a plurality of productive zones. During production of fluids from the well, it usually is desirable to establish communication with selected zones such that stimulation treatments do not inadvertently flow into a non-productive zone or a zone of diminished interest. The need for selective stimulation increases as the life of the well declines and productivity of the well decreases.

Reservoir monitoring is used to assess the productivity of zones from which fluids are being produced. In addition, monitoring of produced fluids is important in order to increase efficiency of the fracturing operation. In the past, tracers have been placed in packs in strategic areas within the well. Unfortunately, monitoring following placement of the tracer within the well is relatively short. Further, placement of tracers into defined areas within the well does not offer a means for controlling the release of the tracer within the well. U.S. Pat. No. 9,874,080 discloses a method of slowly releasing a tracer into a productive zone by introducing into the zone a tracer immobilized onto a support. Alternatives have been sought which will provide a more effective means for controlling the release of the tracer, such as over a more prolonged period of time.

Alternatives have also been sought to address the deleterious effects caused by severe downhole conditions encountered during the production of oil, gas and water. Such downhole conditions include heat, pressure and turbulence. These conditions contribute to the formation and deposition of scales, salts, gas hydrates and paraffins; precipitation of asphaltenes; formation of emulsions (both water-in-oil and oil-in-water); and formation of rust in tubulars within the well and conduits extending from and to the well. These contaminants decrease permeability of the subterranean formation and reduce well productivity. In acute situations, the lifetime of production equipment is shortened. Further, in order to rid such contaminants from wells, tubulars, flow conduits and equipment, it typically is necessary to stop production. This is both time-consuming and costly.

Several methods have been employed for introducing well treatment agents into production wells. For instance, a liquid well treatment agent may be forced into the formation by application of hydraulic pressure from the surface which forces the treatment agent into the targeted zone. Alternatively, the delivery method may consist of placing a solid well treatment agent into the producing formation in conjunction with a hydraulic fracturing operation. A principal disadvantage of such methods is the difficulty in releasing the well treatment agent into the well over a sustained period of time. As a result, treatments must repeatedly be undertaken to ensure that the requisite level of treatment agent is continuously present in the well. Such treatments result in lost production revenue due to down time.

U.S. Pat. Nos. 7,491,682; 7,493,955; 9,010,430; 9,029,300; and 9,656,237 disclose the use of composites for the slow release of well treatment agents. While composites have been successful in the slow release of well treatment agents during well treatment operations, methods of improving the slow or delayed release of well treatment agents as well as improved methods for delivering such treatment agents into wells, formations, conduits and/or vessels have been sought.

It should be understood that the above-described discussion is provided for illustrative purposes only and is not intended to limit the scope or subject matter of the appended claims or those of any related patent application or patent.

### SUMMARY OF THE DISCLOSURE

In an embodiment, a method of controlling the release of a well treatment agent in a well or within a subterranean formation penetrated by a well is provided. In this embodiment, a composite comprising the well treatment agent adsorbed onto an oil-insoluble and water-insoluble adsorbent is pumped into the well. The well treatment agent inhibits or controls the formation of contaminants in the well or within the subterranean formation by slowly releasing the well treatment agent from the composite. The surface area of the adsorbent is between from about 110 m²/g to about 700 m²/g.

In another embodiment, a method of inhibiting or preventing the formation of contaminants (a) into a fluid within a well penetrating a subterranean formation, (b) onto the surface of a subterranean formation penetrated by a well, or (c) onto the surface of a conduit in an underground reservoir or a conduit extending to or from the underground reservoir is provided. In this embodiment, composite comprising a contaminant inhibiting or preventing effective amount of a treatment agent adsorbed onto an oil-insoluble and water-insoluble adsorbent is introduced into the well or conduit. The surface area of the oil-insoluble and water-insoluble adsorbent is from about 110 to about 700 m²/g.

In another embodiment, a method of controlling the rate of release of a well treatment agent in a well or within a subterranean formation penetrated by a well during a stimulation or sand control operation is provided. In this embodiment, a composite comprising the well treatment agent adsorbed onto an oil-insoluble and water-insoluble adsorbent is pumped into the well. The well treatment agent inhibits or controls the formation of contaminants within the well or within the subterranean formation by being released from the composite over a period of at least nine months. The surface area of the adsorbent is between from about 110 m²/g to about 700 m²/g.

In another embodiment, a method of fracturing multiple subterranean zones surrounded by a wellbore is provided. In this embodiment, a fracturing fluid having a composite comprising a hydrocarbon soluble, water soluble or both hydrocarbon and water soluble tracer adsorbed onto an oil-insoluble or water-insoluble adsorbent, wherein the surface area of the adsorbent is between from about 110 m²/g to about 700 m²/g, is pumped into each zone to be fractured. The tracer introduced into each zone is qualitatively and quantitatively distinguishable. A fracture is enlarged or created in the zone. The tracer is solubilized (desorbed from the adsorbent) into fluids produced from the zone into which the composite is pumped. Fluid is recovered from at least one of the productive zones. The zone within the subterranean formation from which the recovered fluid was produced is then identified from the tracer in the recovered fluid.

In another embodiment, a method of fracturing multiple productive zones surrounded by a wellbore is provided wherein the amount of produced fluids from at least one of the multiple productive zones is measured. In this embodiment, a fracturing fluid is pumped into the multiple productive zones at a pressure sufficient to enlarge or create fracture(s) in the multiple productive zones. The fracturing fluid is then pumped into the multiple productive zones. The fracturing fluid contains a composite having a hydrocarbon soluble, water soluble or both hydrocarbon soluble and water soluble tracer adsorbed onto a water-insoluble and oil-insoluble adsorbent. The surface area of the adsorbent is between from about 110 m²/g to about 700 m²/g. The fracturing fluid pumped into each of the multiple productive zones contains a different pre-determined tracer adsorbed onto the water-insoluble and oil-insoluble adsorbent. The pre-determined tracer is solubilized (desorbed) into fluids produced from the productive zone into which the composite comprising the pre-determined tracer is pumped. The amount of the solubilized tracer in hydrocarbons produced from the well is quantitatively determined. The amount of hydrocarbons produced from the one or more multiple productive zones is determined from the solubilized tracer.

In another embodiment, a method of monitoring the production of fluids produced in one or more productive zones of a subterranean formation penetrated by a well is provided. In this embodiment, fracturing fluid is pumped into the multiple productive zones at a pressure sufficient to enlarge or create fracture(s) in each of the multiple productive zones. The fracturing fluid contains a composite comprising a hydrocarbon soluble, water soluble or both hydrocarbon soluble and water soluble tracer adsorbed onto an oil-insoluble and water-insoluble adsorbent. The surface area of the adsorbent is between from about 110 m²/g to about 700 m²/g. The tracer pumped into each of the multiple productive zones is qualitatively and/or quantitatively distinguishable. Fluids produced from the multiple productive zones may be determined from the tracer in the produced fluid. Further, the amount of fluid produced from one or more productive zones may be determined.

In another embodiment, a method of quantitatively monitoring the amount of fluids produced in one or more productive zones penetrated by a wellbore is provided. In this embodiment, a fracturing fluid is pumped into the productive zones at a pressure sufficient to enlarge or create a fracture(s). The fracturing fluid contains a composite of a hydrocarbon soluble, water soluble or both hydrocarbon soluble and water soluble tracer adsorbed onto a water-insoluble and oil-insoluble adsorbent. The surface area of the adsorbent is between from about 110 m²/g to about 700 m²/g. The composite pumped into each of the multiple productive zones has a different tracer adsorbed onto the water-insoluble and oil-insoluble adsorbent. The fluids produced from each of the multiple productive zones is quantitatively detectable by the tracer. Over a period of at least nine months, the tracer is solubilized (desorbed) into fluids produced from the productive zone into which the composite comprising the tracer is pumped. The amount of fluids produced from each of the multiple productive zones is determined and monitored by detecting the amount of tracer in the produced fluid. The produced fluid are hydrocarbons, water or both hydrocarbons and water.

In another embodiment of the disclosure, a method of inhibiting the formation or deposition of contaminants in a fracture propped open with proppants having a particle size no greater than 150 μm is provided. In this method, a composite comprising a hydrocarbon soluble, water soluble or both hydrocarbon and water soluble well treatment agent adsorbed onto a water-insoluble and oil-insoluble adsorbent is introduced into the fracture. The surface area of the adsorbent is between from about 110 m²/g to about 700 m²/g. The particle size of the composite is less than or equal to the particle size of the proppant. The well treatment agent is solubilized (desorbed) by fluids within the fracture and slowly released from the composite.

In another embodiment, a method of controlling the rate of release of a hydrocarbon soluble, water soluble or both hydrocarbon and water soluble well treatment agent into a dendritic fracture extending from a primary fracturing during a hydraulic fracturing operation is provided. In this embodiment, a composite having the well treatment agent adsorbed onto a water-insoluble and oil-insoluble adsorbent is pumped into near field primary fractures and far field secondary fractures propped open with a proppant having a particle size less than or equal to 150 μm. The surface area of the adsorbent is between from about 110 m²/g to about 700 m²/g. The particle size of the composite is less than or equal to the particle size of the proppant. The well treatment agent is released from the composite.

In another embodiment, a method of increasing hydrocarbon production from a production well penetrating a hydrocarbon-bearing reservoirs provided wherein more than one injection well is associated with the production well. In this embodiment, an aqueous fluid is injected into the more than one injection well, the aqueous fluid having a hydrocarbon soluble, water soluble or both hydrocarbon soluble and water soluble tracer adsorbed onto a water-insoluble and oil-insoluble adsorbent. The surface area of the adsorbent is between from about 110 m²/g to about 700 m²/g. Pressure is maintained in the hydrocarbon-bearing reservoir above the bubble point of the hydrocarbons in the reservoir. The aqueous fluid pumped into each of the injection wells contains qualitatively distinguishable tracers on the surface of the adsorbent. The injection well into which breakthrough water was injected may be identified from hydrocarbons recovered from the production well upon water breakthrough in the production well by qualitatively determining the presence of the tracer in the recovered hydrocarbons. The injector well identified may then be shut off.

In another embodiment, a method of increasing hydrocarbon production from a production well penetrating a hydrocarbon-bearing reservoir is provided wherein more than one injection well is associated with the production well. In this embodiment, an aqueous fluid is injected into the injection wells. The aqueous fluid has a hydrocarbon soluble, water soluble or both hydrocarbon and water soluble tracer adsorbed onto a water-insoluble and oil-insoluble adsorbent. The surface area of the adsorbent is between from about 110 m²/g to about 700 m²/g. Pressure is maintained in the hydrocarbon-bearing reservoir. From the hydrocarbons recovered from the production well, upon water breakthrough in the production well, the injection well into which the breakthrough water was injected may be identified by qualitatively determining the presence of the tracer in the recovered hydrocarbons. The identified injection well may then be shut off.

In another embodiment, a method for determining water breakthrough in a production well associated with one or more injector wells is provided. In this method, an aqueous fluid is injected into an injector well. The aqueous fluid contains a tracer adsorbed onto a water-insoluble and oil-insoluble adsorbent. The surface area of the adsorbent is between from about 110 m²/g to about 700 m²/g. The aqueous fluid from the injector well then flows into the production well. Fluid is produced in the production well. Water breakthrough in the production well may then be determined by qualitatively determining the presence or quantitatively measuring the amount of the tracer in the produced fluid.

### BRIEF DESCRIPTION OF THE DRAWINGS

The following figures are part of the present specification, included to demonstrate certain aspects of various embodiments of this disclosure and referenced in the detailed description wherein:

FIG. 1 and FIG. 2 demonstrate the increased longevity exhibited by the composites defined herein compared to composites previously reported.

### DETAILED DESCRIPTION OF THE PREFERRED EMBODIMENTS

Characteristics and advantages of the present disclosure and additional features and benefits will be readily apparent to those skilled in the art upon consideration of the following detailed description of exemplary embodiments of the present disclosure and referring to the accompanying figures. It should be understood that the description herein, being of example embodiments, are not intended to limit the claims. On the contrary, the intention is to cover all modifications, equivalents and alternatives falling within the spirit and scope of the claims. Many changes may be made to the particular embodiments and details disclosed herein without departing from such spirit and scope.

As used herein, the terms “disclosure”, “present disclosure” and variations thereof are not intended to mean every possible embodiment encompassed by this disclosure or any particular claim(s). Thus, the subject matter of each such reference should not be considered as necessary for, or part of, every embodiment hereof or of any particular claim(s) merely because of such reference.

Certain terms are used herein and in the appended claims to refer to particular components. As one skilled in the art will appreciate, different persons may refer to a component by different names. This document does not intend to distinguish between components that differ in name but not function. Also, the terms “including” and “comprising” are used herein and in the appended claims in an open-ended fashion, and thus should be interpreted to mean “including, but not limited to . . . . ” Further, reference herein and in the appended claims to components and aspects in a singular tense does not necessarily limit the present disclosure or appended claims to only one such component or aspect, but should be interpreted generally to mean one or more, as may be suitable and desirable in each particular instance.

All ranges disclosed herein are inclusive of the endpoints. Unless stated otherwise, any range of values within the endpoints is encompassed. For example, where the endpoints of a range are stated to be from 1 to 10, any range of values, such as from 2 to 6 or from 3 to 5 will be defined by the range. The suffix “(s)” as used herein is intended to include both the singular and the plural of the term that it modifies, thereby including at least one of that term. All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context.

A composite for use in the disclosure comprises at least one well treatment agent and an adsorbent. The well treatment agent is adsorbed onto the substrate. Over time, the well treatment agent disassociates from the adsorbent under in-situ conditions. The well treatment agent remains intact on the solid adsorbent until prolonged contact with a solubilizing liquid.

The well treatment agent is generally capable of being dissolved at a generally constant rate over an extended period.

Typically, the specific gravity of the composite is less than or equal to 3.75 g/cc.

The surface area of the adsorbent of the well treating composite is typically greater than 110 m²/g, and typically from about 110 m²/g to about 700 m²/g.

The well treatment agent is preferably water soluble or soluble in aliphatic and aromatic hydrocarbons. When fluid is produced in the well, the well treatment agent may be released from the substrate into its respective solubilizing liquid.

The composite does not require excessive amounts of well treatment agents. The amount of well treatment agent in the composite is that amount sufficient to effectuate the desired result over a sustained period of time. For instance, where the well treatment agent is a scale inhibitor, the amount of scale inhibitor present in the composite is that amount required to prevent, or to at least substantially reduce the degree of, scale formation. For most applications, the amount of well treatment agent in the composite may be as low 1 ppm. Generally, the amount of well treatment agent in the composite is from about 0.05 to about 25 (preferably from about 0.1 to about 10) weight percent based upon the total weight of the composite. Typically, the weight ratio of the well treatment agent to adsorbent in the composite is from about 9:1 to about 1:9.

The adsorption of the well treatment agent onto the solid adsorbent limits the availability of the free well treatment agent in water. In addition, the composite itself has limited solubility in water. Typically, the particle size of the composite is less than 150 μm, more typically less than 100 μm and often less than 50 μm. The larger surface area of the adsorbent and the smaller particle size of the composite enables the composite to be used over prolonged periods compared to composites previously disclosed. When placed into a production well, the well treatment agent slowly dissolves at a generally constant rate over an extended period of time in the water and/or hydrocarbon contained in the formation. The controlled slow release of the agent may be dependent upon any surface charges between the well treatment agent and adsorbent which, in turn, may be dependent upon the adsorption/desorption properties of the agent to adsorbent.

Typically, the lifetime of the composite may be sufficient for up to 1,000 pore volumes of the well treatment agent. The composite typically is effective in a single treatment use for up to 6 months, in most cases greater than 9 months, typically more than 12 months or 18 months and often up to 24 months and in some cases upwards to three to five years. In some cases, this may be dependent on the volume of fluid produced in the production well and the amount of tracer in the composite. Costs of operation are therefore significantly lowered by use of the composite.

The water insoluble adsorbent may be any of various kinds of commercially available high surface area materials which may adsorb to the desired well treatment agent.

Suitable adsorbents include finely divided minerals, fibers, ground almond shells, ground walnut shells, and ground coconut shells. Further suitable water-insoluble adsorbents include activated carbon and/or coals, silica particulates, precipitated silicas, silica (quartz sand), alumina, silica-alumina such as silica gel, mica, silicate, e.g., orthosilicates or metasilicates, calcium silicate, sand (e.g., 20-40 mesh), bauxite, kaolin, talc, zirconia, boron and glass, including glass microspheres or beads, fly ash, zeolites, diatomaceous earth, ground walnut shells, fuller's earth and organic synthetic high molecular weight water-insoluble adsorbents. Particularly preferred are diatomaceous earth and precipitated silica.

Further useful as adsorbents are clays such as natural clays, preferably those having a relatively large negatively charged surface, and a much smaller surface that is positively charged. Other examples of such high surface area materials include such clays as bentonite, illite, montmorillonite and synthetic clays.

In a preferred embodiment, the well treatment agent may be at least one member selected from the group consisting of demulsifying agents (both water-in-oil or oil-in-water), corrosion inhibitors, scale inhibitors, salt inhibitors, paraffin inhibitors, gas hydrate inhibitors, salt formation inhibitors, asphaltene dispersants, foaming agents, oxygen scavengers, hydrogen sulfide scavengers, water soluble tracers, oil soluble tracers, biocides and surfactants as well as other agents wherein slow release into the production well or a tubular or conduit is desired.

The well treatment agent may be a solid or liquid. In an embodiment, where the well treatment agent is a solid, it can be dissolved in a suitable solvent, thus making it a liquid. Where the well treatment agent is a solid, the well treatment agent may remain intact on the solid adsorbent until the flow of a solubilizing liquid. For instance, where the well treatment agent is an inhibitor for scales, corrosion, salts or biocidal action, the treatment agent may solubilize (desorbed from the adsorbent) into produced water. In the absence of water flow, the well treatment agent may remain intact on the solid adsorbent. As another example, solid inhibitors for paraffin or asphaltene solubilize into the hydrocarbon phase of produced fluid.

Suitable scale inhibitors are anionic scale inhibitors.

Preferred scale inhibitors include strong acidic materials such as a phosphonic acid, a phosphoric acid or a phosphorous acid, phosphate esters, phosphonate/phosphonic acids, the various aminopoly carboxylic acids, chelating agents, and polymeric inhibitors and salts thereof. Included are organo phosphonates, organo phosphates and phosphate esters as well as the corresponding acids and salts thereof.

Phosphonate/phosphonic acid type scale inhibitors are often preferred in light of their effectiveness to control scales at relatively low concentration. Polymeric scale inhibitors, such as polyacrylamides, salts of acrylamido-methyl propane sulfonate/acrylic acid copolymer (AMPS/AA), phosphinated maleic copolymer (PHOS/MA) or sodium salt of polymaleic acid/acrylic acid/acrylamido-methyl propane sulfonate terpolymers (PMA/AMPS), are also effective scale inhibitors. Sodium salts are preferred.

Further useful, especially for brines, are chelating agents, including diethylenetriaminepentamethylene phosphonic acid and ethylenediaminetetra acetic acid.

Suitable salt inhibitors include any of the fructans or fructan derivatives, such as inulin and inulin derivatives, as disclosed in U.S. Patent Publication No. 2009/0325825, herein incorporated by reference.

Exemplary of the demulsifying agents that are useful include, but are not limited to, condensation polymers of alkylene oxides and glycols, such as ethylene oxide and propylene oxide condensation polymers of di-propylene glycol as well as trimethylol propane; and alkyl substituted phenol formaldehyde resins, bis-phenyl diepoxides, and esters and diesters of the such di-functional products. Especially preferred as non-ionic demulsifiers are oxyalkylated phenol formaldehyde resins, oxyalkylated amines and polyamines, di-epoxidized oxyalkylated polyethers, etc. Suitable oil-in-water demulsifiers include poly triethanolamine methyl chloride quaternary, melamine acid colloid, aminomethylated polyacrylamide etc.

Paraffin inhibitors useful for the composites include, but are not limited to, ethylene/vinyl acetate copolymers, acrylates (such as polyacrylate esters and methacrylate esters of fatty alcohols), and olefin/maleic esters.

Exemplary corrosion inhibitors useful herein include but are not limited to fatty imidazolines, alkyl pyridines, alkyl pyridine quaternaries, fatty amine quaternaries and phosphate salts of fatty imidazolines.

Gas hydrate treating chemicals or inhibitors that are useful include but are not limited to polymers and homopolymers and copolymers of vinyl pyrrolidone, vinyl caprolactam and amine based hydrate inhibitors such as those disclosed in U.S. Patent Publication Nos. 2006/0223713 and 2009/0325823, both of which are herein incorporated by reference.

Exemplary asphaltene treating chemicals include but are not limited to fatty ester homopolymers and copolymers (such as fatty esters of acrylic and methacrylic acid polymers and copolymers) and sorbitan monooleate.

Suitable foaming agents include, but are not limited to, oxyalkylated sulfates or ethoxylated alcohol sulfates, or mixtures thereof.

Exemplary surfactants include cationic, amphoteric, anionic and nonionic surfactants. Included as cationic surfactants are those containing a quaternary ammonium moiety (such as a linear quaternary amine, a benzyl quaternary amine or a quaternary ammonium halide), a quaternary sulfonium moiety or a quaternary phosphonium moiety or mixtures thereof. Suitable surfactants containing a quaternary group include quaternary ammonium halide or quaternary amine, such as quaternary ammonium chloride or a quaternary ammonium bromide. Included as amphoteric surfactants are glycinates, amphoacetates, propionates, betaines and mixtures thereof. The cationic or amphoteric surfactant may have a hydrophobic tail (which may be saturated or unsaturated) such as a C12-C18 carbon chain length. Further, the hydrophobic tail may be obtained from a natural oil from plants such as one or more of coconut oil, rapeseed oil and palm oil.

Preferred surfactants include N,N,N trimethyl-1-octadecammonium chloride: N,N,N trimethyl-1-hexadecammonium chloride; and N,N,N trimethyl-1-soyaammonium chloride, and mixtures thereof. Suitable anionic surfactants are sulfonates (like sodium xylene sulfonate and sodium naphthalene sulfonate), phosphonates, ethoxysulfates and mixtures thereof.

Exemplary oxygen scavengers include triazines, maleimides, formaldehydes, amines, carboxamides, alkylcarboxyl-azo compounds cumine-peroxide compounds morpholino and amino derivatives morpholine and piperazine derivatives, amine oxides, alkanolamines, aliphatic and aromatic polyamines.

The hydrogen sulfide scavenger may be an oxidant, such as an inorganic peroxide, e.g. sodium peroxide, or chlorine dioxide, or an aldehyde, e.g. of 1 to 10 carbons such as formaldehyde or glutaraldehyde or (meth)acrolein or an amine based scavenger, such as a triazine or a hexamine.

Suitable tracers include dyes (such as phenoxazone dyes, fluroescein, pyridinium betaines dyes, solvatochromatic dyes, Oregon Green, Cascade Blue, Lucifer yellow, Auramine O, tetramethylrhodamine, pysranine, sulforhodamines, hydroxycoumarins; polysulfonated pyrenes; cyanines, hydroxylamines, neutral red, acridine orange; acids (such as picric acid and salicylic acid) or salts thereof; ionizable compounds (such as those which provide ammonium, boron, chromate, etc., ions); and radioactive materials (such as krypton-85); isotopes; genetically or biologically coded materials; microorganisms; minerals; and high molecular weight synthetic and natural compounds and polymers (such as oligonucleotides, perfluorinated hydrocarbons like perfluoro butane, perfluoro methyl cyclopentane and perfluoro methyl cyclohexane).

The tracer may also be a chelate, such as ethylene diamine tetra acetic acid (EDTA)) or a salt thereof. U.S. Pat. No. 4,264,329, herein incorporated by reference, discloses acceptable metal chelates formed by reacting aryl substituted ethylene diamine tetra acetic acid and a metal ion selected from the consisting of lead, cadmium and zinc. Such chelates react with fluorogenic agents, such as fluorescamine and o-phthalaldehyde. Fluorescence spectroscopy is then used to detect the chelate.

The weight ratio of well treatment agent to water-insoluble adsorbent is generally between from about 90:10 to about 10:90.

In an embodiment, the composite may be transported into the formation, tubular or conduit in a carrier fluid. The well treatment agent may be released into a targeted area in the well, formation, tubular, conduit, etc. The composite provides a continuous supply of the well treatment agent into the targeted area.

Suitable carriers include aqueous based systems like brines, such as a saturated potassium chloride or sodium chloride brine, salt water such as seawater or fresh water. In other embodiments, the composite may be carried into the formation, tubular or conduit in a liquid hydrocarbon, surfactant or gas, such as nitrogen or carbon dioxide. The composites may further be injected into the formation in liquefied gas, such as liquefied natural gas or liquefied petroleum gas as well as in foams, such as carbon dioxide, nitrogen and carbon dioxide/nitrogen. The fluid is preferably aqueous, steam or gas.

In an embodiment, the composites defined herein may be slurried into a brine or into an aliphatic or aromatic hydrocarbon. A thickener may optionally be added to the slurry to provide a viscous fluid. Suitable viscosifiers include clay and clay-like materials and conventional polysaccharides such as cellulose, starch, and galactomannan gums as well as polyvinyl alcohols, polyacrylates, polypyrrolidones and polyacrylamides and mixtures thereof.

The amount of composite present in the composition is typically between from about 15 ppm to about 100,000 ppm depending upon the severity of the scale deposition. When the carrier fluid is brine, the weight percentage of the composite in the composition is generally between from about 0.02 to about 2 weight percent.

The composition may further contain between from 0 to about 10 weight percent of an inorganic salt. Suitable inorganic salts include KCl, NaCl, and NH₄Cl.

The composite may also be compressed into a shaped article and the shaped article may be placed into the well, tubular, conduit, etc. The shaped article may be in the form of a sphere, cylinder, rod or any other shape which allows for the slow release of the well treatment agent into the targeted area. In a preferred embodiment, the shaped articles are shaped pellets. The specific gravity of the shaped articles is generally between from about 1.1 to about 3. In a preferred embodiment, the specific gravity of the shaped articles is between from about 2 to about 2.5.

Use of shaped articles renders unnecessary the use of burdensome mechanical tools and procedures. While the shaped compressed articles may be used to treat any type of well that requires chemical treatment, they have particular applicability in the treatment of production wells where traditional mechanical means such as wire lines or coil tubing have been unable to reach. For instance, the shaped articles may be introduced directly into production tubing by being dropped directly into the well head or may be placed in a receptacle and lowered into the well.

When introduced into production tubing within the well, the shape and specific gravity of the shaped articles causes the particulates to flow past obstructions and through well deviations such that the articles may be placed at or in close proximity to the targeted area where treatment is desired. Continuous release of the well treatment agent with the production fluid further protects the tubular and the surface equipment from unwanted deposits which may otherwise be formed. Production from the well is thereby improved.

When formed to resemble hockey pucks, the shaped articles may be placed into a receptacle and suspended at distant locations within the well. When the well treatment agent is depleted within the receptacle, the receptacle may then be pulled to the surface and reloaded with additional pellets. In a preferred embodiment, where the shaped article is to be directly dropped into the well from the well head, the article is preferably spherical and is formed into a ball-like sphere having a diameter between from about ½ inch to about 3 inches, more preferably from about ¾ inch to about 2½ inches, most preferably approximately 1¾ inch. Such spheres resemble spherical balls.

The shaped particulates may be produced by procedures known in the art. Typically the shaped particulates are formed by combining the composite and, optional, weighting agent, with a binder and then compressing the mixture in a mold of the desired shape or extruding the mixture into its desired shape.

Exemplary of the process for making the shaped particulates is to combine the composite, prepared in accordance with the teachings set forth in U.S. Pat. No. 7,493,955 or 7,494,711, with an organic binder and then compressing the mixture at a temperature between from about 20° C. to about 50° C. at a pressure of from between 50 to about 5000 psi. The hardened particulates may then be screened to the desired size and shape. In another preferred embodiment, the shaped composites are produced by a continuous extrusion at a temperature between from about 400° C. to about and 800° C.

The binder, to which the composite is added, generally serves to hold the well treatment agent and any desired additives agents together during compression. Suitable binders may be an organic binder or inorganic binder. Typical organic binders are those selected from resole or novolac resins, such as phenolic resole or novolac resins, epoxy-modified novolac resins, epoxy resins, polyurethane resins, alkaline modified phenolic resoles curable with an ester, melamine resins, urea-aldehyde resins, urea-phenol-aldehyde resins, furans, synthetic rubbers, silanes, siloxanes, polyisocyanates, polyepoxys, polymethylmethacrylates, methyl celluloses, crosslink entangled polystyrene divinylbenzenes, and plastics of such polymers as polyesters, polyamides, polyimides, polyethylenes, polypropylenes, polystyrenes, polyolefins, polyvinyl alcohols, polyvinylacetates, silyl-modified polyamides and, optionally, a crosslinking agent. Typical inorganic binders include silicates, e.g., sodium silicate, aluminosilicates, phosphates, e.g., polyphosphate glass, borates, or mixtures thereof, e.g., silicate and phosphate.

The amount of binder added to the composite to form the compressed article is typically from about 0.5 to about 50, preferably from about 1 to about 5 percent based on the total weight of the binder and composite, prior to compression.

Prior to being shaped, a weighting agent may be combined with the composite and binder to impart to the shaped article a higher specific gravity. When present, the amount of weighting agent added to the composite is that amount needed to adjust the specific gravity of the shaped particulate to the requirements of the treated well. Suitable weighting agents include sand, glass, hematite, silica, sand, aluminosilicate, and an alkali metal salt or trimanganese tetraoxide.

The shaped particulates may further be coated with a resin, plastic or sealant which is resistant to the hydrocarbons produced in the well. Suitable resins include phenolic resins like phenol formaldehyde resins, melamine formaldehyde resins, urethane resins, epoxy resins, polyamides, such as nylon, polyethylene, polystyrene, furan resins or a combination thereof.

The coating layer serves to strengthen the compressed article, protect the article from harsh environmental conditions, protect the article from rupturing as it is lowered into the well and to lengthen the time of release of the well treatment agent from the article. The coating layer may be applied to the article by mixing the article and coating material in a vessel at elevated temperatures, typically from about 200 to about 350, preferably around 250° F. An adherent, such as a resin adhesive or tackifying resin, may further be added to the vessel during mixing. The adherent may be used to assist the adhesion of the coating onto the compressed article. Alternatively, the coating layer may also be applied as a spray in a solvent based coating on the compressed article and then dried to remove the solvent.

A coating may also be applied onto at least a portion of the surface of the composite containing the well treatment agent adsorbed onto the hydrocarbon insoluble and water insoluble adsorbent. Release of the well treatment agent into a targeted area may be further controlled by the coating on the composite. The time for solubilization (desorption from the adsorbent) of the well treatment agent is increased by the presence of the release resistant layer. The coating may be a resin, plastic or sealant including any of the resins referenced in the above paragraphs. The coating may be applied onto the composite in the same fashion as referenced above for the coating of the shaped particulate. The adherent may further be used to assist adhesion of the coating onto (at least a portion of) the surface of the composite.

The composites may be used to inhibit or prevent the formation of contaminants or retard the release of contaminants into a fluid within a well. In another embodiment, contaminants may be inhibited or prevented from forming within a formation or onto the surface of a formation by use of the composites. Further, the composites may be used to inhibit or prevent the formation of contaminants onto the surface of a conduit in an underground reservoir or a conduit which extends to or from the underground reservoir.

Further, the composites may be used in controlling the release of a well treatment agent into a well or within a formation or onto the surface of a tubular, conduit, etc. Such release may be controlled for the life of the composite.

In a preferred embodiment, the composite described herein effectively inhibits, controls, prevents or treats the formation of inorganic scale formations being deposited in subterranean formations, such as wellbores, oil wells, gas wells, water wells and geothermal wells as well as in tubulars, conduits, etc. The composites described herein are particularly efficacious in the treatment of scales of calcium, barium, magnesium salts and the like, including barium sulfate, calcium sulfate, and calcium carbonate scales. The composites may further have applicability in the treatment of other inorganic scales, such as zinc sulfide, iron sulfide, etc.

The composite also has particular applicability in the control and/or prevention or formation of salts, paraffins, gas hydrates, asphaltenes as well as corrosion in formations or onto the surface of tubulars, flow conduits or other equipment exposed to fluids containing such contaminants. Further, other suitable treatment agents include foaming agents, oxygen scavengers, biocides, emulsifiers (both water-in-oil and oil-in-water) and surfactants as well as other agents may be employed with the adsorbent when it is desired to slowly slow release such agents into the production well. Further the treatment agent adsorbed onto the adsorbent may be a tracer which may be used to monitor hydrocarbon production.

The composite may be used in any application where prolonged delayed release of a treatment agent is desired.

In an embodiment, the composite may be used in a stimulation operation, such as hydraulic fracturing (including slickwater fracturing), acidizing, matrix acidizing, etc. The composite may be a component of a stimulation fluid, such as a fracturing fluid, acidizing fluid, or matrix acidizing fluid or may be introduced into the well or formation prior to or subsequent to introduction of a fracturing, acidizing or matrix acidizing fluid. The composite may be also be used in completion services and be incorporated into completion fluids, especially those containing zinc bromide, calcium bromide calcium chloride and sodium bromide brines. Such fluids may be introduced down the annulus of the well and, when desired, flushed with produced water.

The finer size of the composite (typically 100 mesh or finer) enables the composite to be premixed in the early stages of a fracturing operation (often limited to 100 mesh or finer sand). The finer mesh product can be added directly to the proppant blender tub or optionally slurried in with a brine or viscosified aqueous slurry.

In an embodiment, the composites may be used in hydraulic fracturing operations where small fractures have been created or enlarged. For instance, the composites may be used in hydraulic fracturing operations wherein fractures have been propped open with proppants having a particle size no greater than 150 μm. In such cases, the particle size of the composite is less than or equal to the particle size of the proppant. The well treatment agent may then be slowly released into the fracture while or after being solubilized. Such applications are especially useful in the treatment of secondary, dendritic fractures extending transversely to the trajectory of a primary fracture. Such fracture patterns are not uncommon in the treatment of low permeability formations, such as shale. In an embodiment, the well treatment composite may be used in those applications where a primary fracture is formed in the near field around the wellbore and dendritic fractures extend from the primary fracture far field.

In addition to their use in hydraulic fracturing, the composites may be included in fluids used in well treating applications near wellbore and may be directed toward improving wellbore productivity and/or controlling the production of formation sand. Particular examples include gravel packing and “frac-packs.” Typical gravel packing and frac packing methods.

In gravel packing, sand is used to pre-pack a screen to prevent the passage of formation particles or unconsolidated materials from the formation into the wellbore during production of fluids from the formation. Gravel packing is essentially a technique for building a two-stage filter downhole. The filter consists of gravel pack sand and a screen or liner. The gravel pack sand is sized according to the particle size distribution of the unconsolidated materials. The screen or liner has openings that are sized to retain the gravel pack sand. Thus the gravel pack particulates retain the unconsolidated formation materials and the screen or liner retains the gravel pack particulates. The gravel pack particulates and the screen or liner act together to reduce or eliminate the production of the unconsolidated formation materials with the oil or gas production. A slurry of sand introduced into the well further may contain the composites. The slurry is then pumped into the workstring within the well until the slurry is within about 150 to about 300 feet of the primary port. Positioning of a crossover service tool allows the slurry to travel into the screen/casing annulus. Particulates are retained by the screen or liner and the remaining fluid leaks off into the formation allowing a tightly packed sand filter to remain in place. Monitoring the composites provides information of the type and amount of the produced fluid from the formation.

The composites may further be used in a frac pack operation where the unconsolidated formation is hydraulically fractured while a two-stage filter of gravel pack is simultaneously built. In frac packing, the processes of hydraulic fracturing and gravel packing are combined into a single treatment to provide stimulated production and an annular gravel pack to reduce formation sand production.

Further, composites may be used in combination with an acid in an acid fracturing operation. The composites are stable in very low pH also and can be mixed with acids for acid fracturing operations. The acid is a corrosive, very low pH acid which reacts with the surrounding formation. The method is particularly effective with sandstone and carbonate formations. Acids such as hydrochloric acid, formic acid, and acetic acid are injected at high rates and pressures into the formation with the fluid to intentionally cause the formation to fail by inducing a fracture in the subterranean rock. In another embodiment, the fluid of the invention may contain the acid. Fractures, originating adjacent to the wellbore, initiate as two wings growing away from the wellbore in opposite directions. The acid is used to dissolve or etch channels or grooves along the fracture face so that after pressure is relieved and the fracture heals, there continues to exist non-uniform highly conductive channels, allowing unrestrained hydrocarbon flow from the reservoir to the wellbore. In contrast, with propped fracturing, fracture conductivity is maintained by propping open the created fracture with a solid material, such as sand, bauxite, ceramic, and certain lighter weight materials. Conductivity in acid fracturing is obtained by etching of the fracture faces with an etching acid instead of by using proppants to prevent the fracture from closing. Monitoring of the composites provides information of the type and amount of the produced fluid from the formation and the success of the acid fracturing operation.

Composites may further be used, in addition to acid fracturing, in matrix acidizing. In matrix acidizing, a fluid containing an organic or inorganic acid or acid-forming material is injected into the formation below fracture pressure such that the acid or acid-forming material reacts with minerals in the formation. A channel or wormholes is created within the formation. As subsequent fluid is pumped into the formation, it tends to flow along the channel, leaving the rest of the formation untreated. Matrix acidizing is often used to enhance near-wellbore permeability. In addition to enhancing the production of hydrocarbons, blockages caused by natural or man-made conditions may further be removed during matrix acidizing. For instance, formation damage caused by drilling mud invasion and clay migration may also be removed during the process. The use of matrix acidizing is often preferred in the treatment of carbonate formations since the reaction products are soluble in the spent acid. Monitoring of the composites during matrix acidizing informs the operator of the amount of fluids being produced during the operation and further provides a measurement on the value of the matrix acidizing operation.

In a preferred embodiment, the well treatment agent is a hydrocarbon soluble and/or water soluble tracer and the composite is used to monitor the reservoir. As produced fluid passes through or circulates around the composites, the tracer slowly dissolves over a generally constant rate over an extended period of time in the water or hydrocarbons which are contained in the formation and/or well. The composites provide a continuous supply of the tracer into the targeted area. Gradual dissolution of the tracers insures that they are available to produced fluids for extended periods of time.

The amount of tracer in the composite is normally from about 1 to 50 weight percent, preferably from about 14 to about 40 weight percent. In some instances, the amount of tracer in the composite may be as low as 1 ppm. Typically, the minimum amount of tracer in the fracturing fluid is that amount sufficient to permit detection within the produced fluid. The amount of composite present in the fracturing fluid is typically between from about 15 ppm to about 100,000 ppm.

Since the tracers may be detected in recovered produced fluids, the method described herein does not require downhole equipment for detection. Typically, fluids transported out of the well are evaluated and the composites are identified on the fly or at a location distant from the wellbore.

Monitoring of the tracers within fluids may be by visual inspection, chemical analysis, standard spectroscopy methods such as infrared, ultraviolet and mass spectroscopy, spectrophotometric methods, chromatography (including liquid chromatography), ultraviolet light, fluorescence spectroscopy, electrochemical detection, infrared, radioactive analysis, x-ray analysis, PCR techniques combined with sequential analysis, electron capture detection or optical fibers. The selected detection method is based on the properties of the tracer. For instance, where the tracer is an aromatic compound, the method of detection is preferably by ultraviolet light. Where the tracer exhibits fluorescence, the detection method may be by fluorescence spectroscopy.

In an embodiment, the composites may be used to identify fluids produced from the well and in a preferred embodiment, identify the zone from which the fluid was produced. (The term “zone” as used herein may refer to separate formations within a well or separate areas within a single formation within the well.) Fluid pumped into the production well at different locations may contain composites having qualitatively and/or quantitatively tracers.

When multiple zones are being fractured within the wellbore, distinguishable tracers may be introduced into different zones. The tracers may be qualitatively and/or quantitatively detectable. The distinguishable tracers are selected such that a tracer in a fluid pumped into one zone is unable to mask the characteristics of a tracer in a fluid pumped into another zone. The zone within the formation from which recovered fluid is produced may be identified from the tracer in the recovered fluid. Further, the amount of hydrocarbons produced from one or more of the zones may be determined.

Thus, for instance, a first treatment fluid having a composite of a tracer adsorbed onto an adsorbent may be introduced into a first zone of a formation. A second treatment fluid having qualitatively and/or quantitatively distinguishable tracers from the fluid introduced into the first zone may be introduced into a second zone of a formation. The zone from which the fluid is produced may be determined by identifying the tracer. (It is understood that the terms “first” and “second” need not be sequential and only denote the order of addition of the fluids into the formation or the order of addition of zones treated in a formation. In other words, the first zone is merely penultimate to the second zone. Thus, for example, the “first zone” may refer to a third zone of a multi-zone formation and the “second zone” may refer to a sixth zone of a multi-zone formation; the “first treatment fluid” may be a fourth treatment fluid introduced while the “second treatment fluid” may be the eighth treatment fluid introduced.)

In addition to monitoring different zones in hydrocarbon production wells and determining the zone in which hydrocarbons have been produced from the formation, the composites may also be used to monitor oil and gas for flow assurance and for maintaining regulatory compliance. The ability to analyze the fluids on-site, quickly and frequently, further assists operators to detect flow assurance, asset integrity and process problems early enabling them to take preventative action to minimize the risks of production loss and to adapt the treatment operation.

The composites may also be used to sweep a production well in an enhanced oil recovery (EOR) operation, such as flooding. Composites may be introduced into injection fluid and the injection fluid introduced into the formation. The injection fluid may be introduced by being pumped into one or more injection wells. Typically, the composites are soluble in the injection fluid.

The detection of the composites in fluids produced from the production well is indicative that the sweep, i.e., removal of the oil from pore spaces within the formation, has been completed.

Further, the composites may also be used to determine sites of flowback water and produced water as well as for detection or early warning of phenomena such as water breakthrough.

In yet other embodiments, the composites may be used as a tracer to determine fluid flow paths through the subterranean formation and into produced fluids. For instance, the composites may be introduced into an injection fluids during at least one of water flooding, steam assisted gravity drainage, steam flooding, cyclic steam stimulation, or other enhanced oil recovery stimulation processes.

In an embodiment, different composites, distinguishable from each other, may be introduced in an aqueous fluid into different injection wells. Fluids produced from the well may be analyzed to determine if water breakthrough has occurred in the production well. By using different composites in different fluids, the injection well from which the water in the breakthrough water was pumped may be determined by optical spectroscopy. The injection well, into which the water in the breakthrough water has been determined to have been initially introduced, can be shut off. Thus, the composites can be used to optimize enhancement of hydrocarbons during secondary recovery operations by shutting down the injection well feeding into the formation into which sweep efficiency has been maximized. Thus, the flow of water from the injection well into that portion of the formation having been completely swept may be terminated.

In an embodiment, the composites may be introduced into an aqueous fluid which is then introduced into injection wells. The aqueous fluid introduced into each of the injection wells contains a qualitatively distinguishable tracer. The aqueous fluid serves to maintain pressure in the hydrocarbon-bearing reservoir. The pressure is maintained above the bubble point. Should tracers be detected in produced fluid from the production well, the operator would know to take remedial action and shut down the injection well from which the tracers had originally been introduced. The injection well, once shut down, may be repaired to prevent further flow of aqueous fluid into the production well.

### EXAMPLES

All percentages set forth in the Examples are given in terms of weight units except as may otherwise be indicated.

### Example 1. Preparation of Scale Inhibitor Composites

Composite A. About 120 g of precipitated silica having a surface area of 500 m²/g (ISO 9277:2010), commercially available as Sipernat 50 from Evonik Industries, was mixed using a paddle mixer in a mixing bowl. About 280 g of a 50% solution of polyether amino phosphonate, commercially available as Arquest® 6115 from Baker Hughes, a GE company, LLC, was then added. The product was intimately mixed until all the liquid was visibly adsorbed and then air dried. The composite product had approximately 35% by wt. of active phosphonate scale inhibitor adsorbed onto the substrate.
Comparative Composite. About 800 g of diatomaceous earth having specific surface area of 30 to 45 m²/g (ISO 9277:2010), commercially available as Celite MP-79 was added into a mixing bowl. A paddle mixer blade was attached and liquid organophosphate, commercially available as Solutia Dequest 2000, was added to the mixing bowl at a rate in which the liquid was readily absorbed, and the liquid did not puddle. After all of the liquid was added, mixing was continued until a homogenous blend was produced. The blend was then dried at 225° F. until the percent moisture of the resulting product was less than 3%. The composite thus prepared contained 25 percent by weight of organophosphate scale inhibitor. The composite corresponds substantially to that disclosed in U.S. Pat. No. 7,491,682.

### Example 2. Evaluation 1 of Longevity of Scale Inhibitor Composite

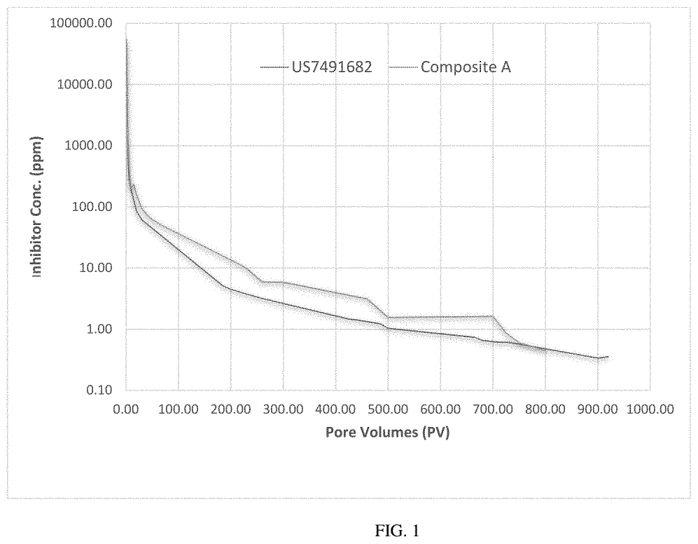

Columns were prepared with ½″ inner diameter stainless steel tubing cut 13⅞″ long and adding zero volume reduction pieces to either end. The column was packed with an intimate mixture of a 51 g 20/40 Ottawa sand and 4 g of the solid inhibitor composites of Example 1. The column was placed into a water bath set at 65° C./150° F. and a brine composition was pumped through the column at 2 cc/min and the eluant captured in a receiving container. The brine composition was 1M NaCl, 0.025M CaCl₂.2H₂O and 0.015 M NaHCO₃. The pore volume of the column was 12 mL. The eluted samples were evaluated for phosphorus in ICP and the inhibitor concentration extrapolated. A comparison of the pore volume elution data, illustrated in FIG. 1, shows the scale inhibitor composite exhibits enhanced duration compared to the Comparative scale inhibitor (“Comparative”). The results are summarized in Table I.

TABLE I

| Inhibitor Conc./ | Comparative | | % Increased |
|---|---|---|---|
| Pore Vols. | Composite | Composite A | Longevity |
| 10 ppm | 140 PVs | 230 PVs | 64% |
| 5 ppm | 190 PVs | 400 PVs | 111% |
| 1 ppm | 500 PVs | 725 PVs | 45% |

As illustrated, the phosphorous level in the pore volumes of Composite A remained above 1 ppm for an extended period of time longer than that of the Comparative Composite. The 1 ppm level is sufficient to prevent the formation of scales and indicates the ability of the scale inhibitor Composite A to render longer term protection than that of the Comparative Composite.

### Example 3

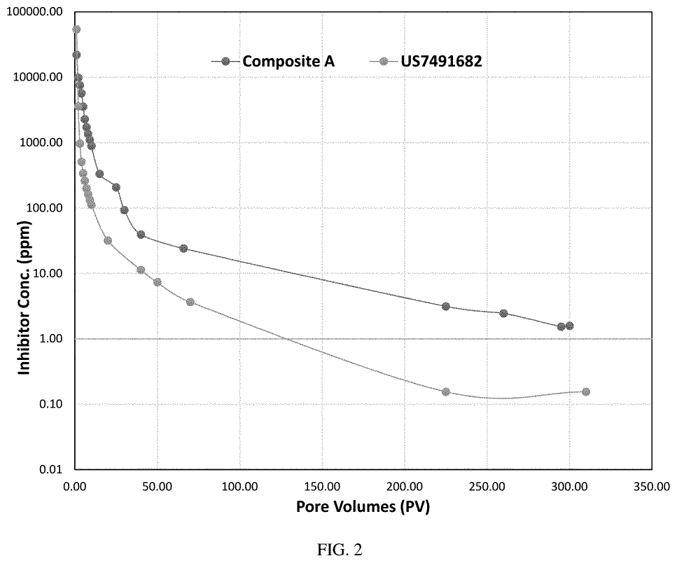

Evaluation 1 of Example 2 was repeated except the column was packed with 2% (versus 4%) of the composites of Example 1. A comparison of the pore volume elution data, illustrated in FIG. 2, shows the scale inhibitor composite exhibits enhanced duration compared to the Comparative scale inhibitor. The results are summarized in Table II.

TABLE II

| Inhibitor Conc./ | Using MP-79 | Current | % Increased |
|---|---|---|---|
| Pore Vols. | (U.S. Pat No. 7,491,682) | invention | Longevity |
| 10 ppm | 40 PV | 125 PV | 212% |
| 5 ppm | 60 PV | 170 PV | 180% |
| 1 ppm | 130 PVs | >300 PV | >130% |

As illustrated, the phosphorous level of Composite A remained above 1 ppm at pore volumes above 300 versus that of the Comparative Composite which remained above 1 ppm until a pore volume of about 125.

### Example 4. Adsorption of Substrates

A 50 g solid substrate was weighed out in a beaker and to it added dropwise water. The contents were then continuously mixed with a spatula. The addition was continued until mixing no longer resulted in a dry flowable powder but became cake-like with clear separation of water. The maximum water that could be added to the substrate maintaining a dry powder was noted and the weight of water added to the substrate weight was reported as a percentage in Table 3. The adsorption capacity of the substrate (% by wt. of water to substrate weight) was then determined. The improvement in adsorption capacity compared to that of the comparative diatomaceous earth was determined. The results are shown in Table III.

TABLE III

| | Specific Surface | | |
|---|---|---|---|
| | Area (ISO 9277: | Adsorption | |
| Adsorbent | 2010), m²/g | Capacity, % | % Improvement |
| Diatomaceous Earth | 35 | 30 | |
| (comparative) | | | |
| Silica | 500 | 70 | >200 |
| Silica | 132 | 40 | 30 |
| Alumina | 254 | 50 | >65 |

The methods that may be described above or claimed herein and any other methods which may fall within the scope of the appended claims can be performed in any desired suitable order and are not necessarily limited to any sequence described herein or as may be listed in the appended claims. Further, the methods of the present disclosure do not necessarily require use of the particular embodiments shown and described herein, but are equally applicable with any other suitable structure, form and configuration of components.

Embodiment 1. A method of controlling the rate of release of a hydrocarbon soluble, water soluble or both hydrocarbon and water soluble well treatment agent into a dendritic fracture extending from a primary fracturing during a hydraulic fracturing operation, the method comprising pumping into near field primary fractures and far field secondary fractures propped open with a proppant having a particle size less than or equal to 150 μm a composite comprising the well treatment agent adsorbed onto a water-insoluble and oil-insoluble adsorbent, wherein the surface area of the adsorbent is between from about.110 m²/g to about 700 m²/g and wherein the particle size of the composite is less than or equal to the particle size of the proppant and releasing from the composite the well treatment agent.

Embodiment 2. A method of controlling the rate of release of a well treatment agent into a well or onto the surface of a subterranean formation penetrated by a well during a stimulation or sand control operation, the method comprising pumping into the well a composite comprising the well treatment agent adsorbed onto a water-insoluble adsorbent, wherein the well treatment agent inhibits or controls the formation of contaminants within the well or onto the surface of the subterranean formation by being released into the well over a period of at least nine months, wherein the surface area of the adsorbent is between from about 110 m²/g to about 700 m²/g.

Embodiment 3. The method of Embodiment 2, wherein the stimulation operation is hydraulic fracturing or acidizing.

Embodiment 4. The method of Embodiment 2, wherein the stimulation operation is slickwater fracturing.

Embodiment 5. The method of Embodiment 2, wherein the particle size of the composite is less than the transverse dimension of a dendritic fracture extending from a primary fracture.

Embodiment 6. A method of fracturing multiple subterranean zones surrounded by a wellbore which comprises:
(a) pumping into each zone to be fractured a fracturing fluid, wherein the fracturing fluid pumped into each zone comprises a composite comprising a hydrocarbon soluble, water soluble or both hydrocarbon and water soluble well treatment agent adsorbed onto a water-insoluble adsorbent, wherein the surface area of the adsorbent is between from about 110 m²/g to about 700 m²/g and further wherein the tracer introduced into each zone is qualitatively and quantitatively distinguishable;
(b) enlarging or creating a fracture in the zone;
(c) solubilizing the tracer into fluids produced from the zone into which the composite comprising the composite is pumped; and
(d) identifying the zone within the subterranean formation from which the recovered fluid was produced by identifying the tracer in the recovered fluid.

Embodiment 7. A method of fracturing multiple productive zones surrounded by a wellbore and measuring the amount of produced fluids from the multiple productive zones, the method comprising:
(a) pumping fracturing fluid into the multiple productive zones at a pressure sufficient to enlarge or create fractures in the multiple productive zones, wherein the fracturing fluid pumped into the multiple productive zones comprises a composite comprising a hydrocarbon soluble, water soluble or both hydrocarbon soluble and water soluble tracer adsorbed onto a water-insoluble and oil-insoluble adsorbent, wherein the surface area of the adsorbent is between from about 110 m²/g to about 700 m²/g, and further wherein the fracturing fluid pumped into each of the multiple productive zones contains a different pre-determined tracer adsorbed onto the water-insoluble and oil-insoluble adsorbent and further wherein fluids produced from each of the multiple productive zones is quantitatively detectable by the pre-determined tracer adsorbed onto the water-insoluble and oil-insoluble adsorbent in the fracturing fluid;
(b) solubilizing the pre-determined tracer into fluids produced from the productive zone into which the composite comprising the immobilized pre-determined tracer is pumped;
(c) quantitatively determining the amount of the solubilized tracers in hydrocarbons produced from the well; and
(d) determining the amount of hydrocarbons produced from the multiple productive zones from the solubilized tracers.

Embodiment 8. A method of controlling the release of a well treatment agent into a well or onto the surface of a subterranean formation penetrated a well, the method comprising pumping into the well a composite comprising the well treatment agent adsorbed onto a water-insoluble adsorbent wherein the well treatment agent inhibits or controls the formation of contaminants within the well by slowly releasing the well treatment agent into the well, wherein the surface area of the adsorbent is between from about 110 m²/g to about 700 m²/g.

Embodiment 9. A method of inhibiting or preventing the formation of contaminants:
(a) into a fluid within a well penetrating a subterranean formation;
(b) onto the surface of a subterranean formation penetrated by a well; or
(c) onto the surface of a conduit in an underground reservoir or a conduit extending to or from the underground reservoir
   the method comprising introducing into the well or conduit a composite comprising a contaminant inhibiting or preventing effective amount of a treatment agent adsorbed onto a water-insoluble adsorbent, wherein the surface area of the water-insoluble adsorbent is from about 110 to about 700 m²/g.

Embodiment 10. A method of quantitatively monitoring the amount of fluids produced in multiple productive zones penetrated by a wellbore, the method comprising:
(a) pumping a fracturing fluid into the multiple productive zones at a pressure sufficient to enlarge or create fractures in each of the multiple productive zones, wherein the fracturing fluid comprises a hydrocarbon soluble, water soluble or both hydrocarbon soluble and water soluble tracer adsorbed onto a water-insoluble and oil-insoluble adsorbent, wherein the surface area of the adsorbent is between from about 110 m²/g to about 700 m²/g, and further wherein the fracturing fluid pumped into each of the multiple productive zones contains a different pre-determined tracer adsorbed onto the water-insoluble and oil-insoluble adsorbent and further wherein fluids produced from each of the multiple productive zones is quantitatively detectable by the immobilized pre-determined tracer in the fracturing fluid;
(b) solubilizing over a period of at least nine months the pre-determined tracer into fluids produced from the productive zone into which the composite comprising the pre-determined tracer is pumped; and
(c) determining and monitoring the amount of fluids produced from each of the multiple productive zones by quantitatively detecting the amount of tracer in the produced fluid, wherein the produced fluid are hydrocarbons, water or both hydrocarbons and water.

Embodiment 11. A method of increasing hydrocarbon production from a production well penetrating a hydrocarbon-bearing reservoir, wherein more than one injection well is associated with the production well, the method comprising:
(a) injecting an aqueous fluid having a hydrocarbon soluble, water soluble or both hydrocarbon soluble and water soluble tracer adsorbed onto a water-insoluble and oil-insoluble adsorbent, wherein the surface area of the adsorbent is between from about 110 m²/g to about 700 m²/g into the more than one injection well and maintaining pressure in the hydrocarbon-bearing reservoir above the bubble point of the hydrocarbons in the reservoir, wherein the aqueous fluid pumped into each of the injection wells contains qualitatively distinguishable tracers on the surface of the adsorbent;
(b) identifying from hydrocarbons recovered from the production well, upon water breakthrough in the production well, the injection well into which the breakthrough water was injected by qualitatively determining the presence of the tracer in the recovered hydrocarbons; and
(c) shutting off the injector well identified in step (b).

Embodiment 12. A method of increasing hydrocarbon production from a production well penetrating a hydrocarbon-bearing reservoir, wherein more than one injection well is associated with the production well, the method comprising:
(a) injecting into the more than one injection well an aqueous fluid having a hydrocarbon soluble, water soluble or both hydrocarbon and water soluble tracer adsorbed onto a water-insoluble and oil-insoluble adsorbent, wherein the surface area of the adsorbent is between from about 110 m²/g to about 700 m²/g and maintaining pressure in the hydrocarbon-bearing reservoir;
(b) identifying from hydrocarbons recovered from the production well, upon water breakthrough in the production well, the injection well into which the breakthrough water was injected by qualitatively determining the presence of the tracer in the recovered hydrocarbons; and
(c) shutting off the injection well identified in step (b).

Embodiment 13. The method of any of Embodiments 1 to 12, wherein the weight ratio of the well treatment agent to adsorbent in the composite is between from about 9:1 to about 1:9.

Embodiment 14. The method of any of Embodiments 4 to 13, wherein the lifetime of the composite after being introduced into the well is at least nine months.

Embodiment 15. The method of any of Embodiments 1 to 14, wherein the well treatment agent is selected from the group consisting of scale inhibitors, corrosion inhibitors, paraffin inhibitors, salt inhibitors, gas hydrate inhibitors, asphaltene inhibitors, oxygen scavengers, biocides, foaming agent, emulsion breakers, surfactants, hydrogen sulfide scavengers, water soluble tracers, oil soluble tracers and mixtures thereof.

Embodiment 16. The method of any of Embodiments 1 to 15, wherein the amount of the well treatment agent in the composite is between from about 0.05 to about 25 weight percent.

Embodiment 17. The method of Embodiment 16, wherein the amount of the well treatment agent in the composite is between from about 0.1 to about 10 weight percent.

Embodiment 18. The method of any of Embodiments 1 to 17, wherein the water-insoluble adsorbent is selected from the group consisting of activated carbon, silica particulate, precipitated silica, zeolite, diatomaceous earth, ground walnut shells, fuller's earth, alumina and organic synthetic high molecular weight water-insoluble adsorbents.

Embodiment 19. The method of Embodiment 18, wherein the water-insoluble adsorbent is diatomaceous earth or precipitated silica.

Embodiment 20. The method of any of Embodiments 15 to 19, wherein the well treatment agent is a scale inhibitor.

Embodiment 21. The method of any of Embodiments 1 to 20, wherein the amount of composite in a well treatment fluid pumped into the well is between from about 15 ppm to about 100,000 ppm.

Embodiment 22. The method of any of Embodiments 1 to 21, wherein at least a portion of the surface of the composite is coated with a release resistant layer.

Embodiment 23. The method of Embodiment 22, wherein the release resistant layer is a resin, plastic or sealant.

Embodiment 24. The method of Embodiment 22, wherein the release resistant layer is selected from the group consisting of phenol formaldehyde resins, melamine formaldehyde resins, urethane resins, epoxy resins, polyamides, polyethylene, polystyrene, furan resins and mixtures thereof.

Embodiment 25. The method of any of Embodiments 1 to 24, wherein a shaped compressed pellet containing the composite and a binder is pumped into the well.

Embodiment 26. The method of any of Embodiments 2 to 25, wherein the particle size of the composite is less than 150 μm.

Embodiment 27. The method of any of Embodiments 1 to 26, wherein the particle size of the composite is less than 100 μm.

Embodiment 28. The method of Embodiment 27, wherein the particle size of the composite is less than 50 μm.

While exemplary embodiments of the disclosure have been shown and described, many variations, modifications and/or changes of the system, apparatus and methods of the present disclosure, such as in the components, details of construction and operation, arrangement of parts and/or methods of use, are possible, contemplated by the patent applicant(s), within the scope of the appended claims, and may be made and used by one of ordinary skill in the art without departing from the spirit or teachings of the disclosure and scope of appended claims. Thus, all matter herein set forth or shown in the accompanying drawings should be interpreted as illustrative, and the scope of the disclosure and the appended claims should not be limited to the embodiments described and shown herein.

What is claimed is:

1. A method of controlling the release of a well treatment agent into a well or onto the surface of a subterranean formation penetrated a well, the method comprising pumping into the well a composite comprising the well treatment agent adsorbed onto a water-insoluble adsorbent wherein the well treatment agent inhibits or controls the formation of contaminants within the well by slowly releasing the well treatment agent into the well, wherein the surface area of the adsorbent is between from about 110 m²/g to about 700 m²/g.

2. The method of claim 1, wherein the release of the well treatment agent is controlled during a stimulation or sand control operation.

3. The method of claim 2, wherein the stimulation operation is hydraulic fracturing or acidizing.

4. The method of claim 2, wherein the stimulation operation is slickwater fracturing.

5. The method of claim 3, wherein the particle size of the composite during hydraulic fracturing is less than the transverse dimension of a dendritic fracture extending from a primary fracture.

6. The method of claim 3, wherein the rate of release of the hydrocarbon soluble, water soluble or both hydrocarbon and water soluble well treatment agent is controlled into a dendritic fracture extending from a primary fracture and further wherein a fluid containing the composite is pumped into near field primary fractures and far field secondary fractures propped open with a proppant having a particle size less than or equal to 150 μm and wherein the particle size of the composite is less than or equal to the particle size of the proppant.

7. A method of fracturing multiple subterranean zones surrounded by a wellbore which comprises:
(a) pumping into each zone to be fractured a fracturing fluid, wherein the fracturing fluid pumped into each zone comprises a composite comprising a hydrocarbon soluble, water soluble or both hydrocarbon and water soluble tracer adsorbed onto a water-insoluble adsorbent, wherein the surface area of the adsorbent is between from about 110 m²/g to about 700 m²/g and further wherein the tracer introduced into each zone is qualitatively and quantitatively distinguishable;
(b) solubilizing the tracer into fluids produced from the zone into which the composite comprising the composite is pumped; and
(c) identifying the zone within the subterranean formation from which the recovered fluid was produced by identifying the tracer in the recovered fluid.

8. The method of claim 7, further wherein:
(i) the fracturing fluid pumped into each of the multiple productive zones contains a different pre-determined tracer adsorbed onto the water-insoluble and oil-insoluble adsorbent and further wherein fluids produced from each of the multiple productive zones is quantitatively detectable by the pre-determined tracer adsorbed onto the water-insoluble and oil-insoluble adsorbent in the fracturing fluid;
(ii) the amount of the solubilized tracers in hydrocarbons produced from the well is quantitatively determined; and
(iii) the amount of hydrocarbons produced from the multiple productive zones is determined from the solubilized tracers.

9. A method of increasing hydrocarbon production from a production well penetrating a hydrocarbon-bearing reservoir, wherein more than one injection well is associated with the production well, the method comprising:
(a) injecting into the more than one injection well an aqueous fluid having a hydrocarbon soluble, water soluble or both hydrocarbon and water soluble tracer adsorbed onto a water-insoluble and oil-insoluble adsorbent, wherein the surface area of the adsorbent is between from about 110 m²/g to about 700 m²/g and maintaining pressure in the hydrocarbon-bearing reservoir;
(b) identifying from hydrocarbons recovered from the production well, upon water breakthrough in the production well, the injection well into which the breakthrough water was injected by qualitatively determining the presence of the tracer in the recovered hydrocarbons; and
(c) shutting off the injection well identified in step (b).

10. The method of claim 9, wherein pressure in the hydrocarbon-bearing reservoir is maintained above the bubble point of the hydrocarbons in the reservoir.

11. The method of any of claims 1 to 10, wherein at least one of the following is true:
(a) the weight ratio of the well treatment agent to adsorbent in the composite is between from about 9:1 to about 1:9.
(b) the lifetime of the composite after being introduced into the well is at least nine months;
(c) the well treatment agent is selected from the group consisting of scale inhibitors, corrosion inhibitors, paraffin inhibitors, salt inhibitors, gas hydrate inhibitors, asphaltene inhibitors, oxygen scavengers, biocides, foaming agent, emulsion breakers, surfactants, hydrogen sulfide scavengers, water soluble tracers, oil soluble tracers and mixtures thereof;
(d) the amount of the well treatment agent in the composite is between from about 0.05 to about 25 weight percent;
(e) the water-insoluble adsorbent is selected from the group consisting of activated carbon, silica particulate, precipitated silica, zeolite, diatomaceous earth, ground walnut shells, fuller's earth, alumina and organic synthetic high molecular weight water-insoluble adsorbents;
(f) the composite is pumped into the well in a fluid further wherein the amount of composite in the fluid is between from about 15 ppm to about 100,000 ppm; or
(g) the particle size of the composite is less than 100 μm.

12. The method of claim 11, wherein one of the following is true:
(a) the adsorbent is diatomaceous earth or precipitated silica; or
(b) the well treatment agent is a scale inhibitor.

13. The method of any of claims 1 to 10, wherein at least a portion of the surface of the composite is coated with a release resistant layer.

14. The method of claim 13, wherein the release resistant layer is selected from the group consisting of phenol formaldehyde resins, melamine formaldehyde resins, urethane resins, epoxy resins, polyamides, polyethylene, polystyrene, furan resins and mixtures thereof.

15. The method of any of claims 1 to 10, wherein the composite and a binder are formed into a shaped compressed pellet and wherein the shaped compressed pellet is pumped into the well.
